(19) United States
(12) Patent Application Publication
(10) Pub. No.: US 2007/0012690 A1
(43) Pub. Date: Jan. 18, 2007

(54) Microwave cooker

(75) Inventors: Sung-Hun Sim, Gyeonggi-Do (KR); Eung-Su Kim, Seoul (KR); Jin-Yul Hu, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/331,033

(22) Filed: Jan. 13, 2006

(30) Foreign Application Priority Data
Jul. 13, 2005 (KR) 63399/2005

(51) Int. Cl. H05B 6/76

(52) U.S. Cl. 219/741

(57) ABSTRACT

A microwave cooker comprises a body having a cooking chamber therein for forming an appearance of the microwave cooker, a microwave source disposed at the body for supplying microwave to the cooking chamber, a door openably coupled to one side of the body for opening and closing the cooking chamber, and a choke seal formed at the door and having a resonant frequency at a frequency region higher than a central frequency of microwave when the cooking chamber is closed by the door, for preventing the microwave from being leaked between the body and the door.

### BACKGROUND OF THE INVENTION

1. Field of the Invention

The present invention relates to a microwave cooker, and more particularly, to a microwave cooker capable of effectively preventing a microwave leakage by enhancing a microwave damping function.

2. Description of the Background Art

A microwave cooker such as a microwave oven, an electric oven, etc. serves to heat and cook food by scanning microwave generated from a magnetron to the food.0

The microwave cooker generally comprises a body having a cooking chamber, and a door coupled to the body for opening and closing the cooking chamber. A gap is formed between the body and the door.

When microwave is leaked through the gap between the body and the door, the microwave does harm to a user's body. Therefore, a microwave leakage from the cooking chamber has to be prevented.

Various methods for preventing the microwave from being leaked from the cooking chamber through the gap between the body and the door have been proposed, in which a capacitive seal, a choke seal, or a ferrite rubber is installed between the body and the door.

The conventional method will be explained in more detail with reference to FIG. 1.

FIG. 1 is a graph showing a microwave damping curve of a microwave cooker in accordance with the conventional art, in which ‘A’ expressed as decibel (dB) denotes a damping degree according to a frequency (f) when the cooking chamber is closed.

In the conventional microwave cooker, a choke seal is formed at the door as a closed curve that surrounds a circumference of an opening of the cooking chamber of the body, and has a depth corresponding to ¼ of a wavelength in order to serve as a shielding portion of microwave. When the cooking chamber of the body is closed by the door, a resonant frequency (f-1) of the choke seal has the same frequency as a central frequency (f-MGT: magnetron) of microwave.

When the cooking chamber is opened, a microwave source for supplying microwave is turned off.

However, in the conventional microwave cooker, microwave is drastically leaked when the door is initially opened.

That is, before the microwave source is completely turned off, the door is opened for a certain section. As the gap between the body and the door is increased when the cooking chamber is initially opened, an electromagnetic characteristic is changed. Accordingly, as shown in FIG. 1, the microwave damping curve is moved to the left side, and thus a damping is performed at a region having an inferior damping function. Therefore, microwave is much leaked through the gap between the body and the door.

The U.S. Pat. No. 6,538,241 (hereinafter, will be referred to as the conventional microwave cooker) discloses a microwave sealing unit for stably performing a damping at a wide frequency region.

The microwave sealing unit has a double resonant structure having two sealing cavities, and a resonant frequency of each cavity is positioned at both sides of a central frequency of microwave. As each resonant frequency has a constant gap therebetween, a gap variation of the door is not greatly influential thereon and thus a damping function can be stably performed at a wide frequency region.

However, in the conventional microwave cooker, as each resonant frequency of the microwave sealing unit is spaced from each other in order to obtain a wide bandwidth, a damping function is lowered at a region between each resonant frequency. Furthermore, since a central frequency of microwave is positioned at a region having an inferior damping function, an optimum damping function of the microwave cooker is not implemented.

The wider a gap between each resonant frequency is (that is, the wider a bandwidth is), the lower a damping function between each resonant frequency is. Therefore, when the gap between the body and the door is more than approximately 4 mm, it is difficult to effectively prevent a microwave leakage.

In the conventional microwave cooker, odor, smoke, etc. generated from food inside the cooking chamber contaminate an inner surface of the door, especially, the choke seal or the microwave sealing unit, and the contaminated portion is not easily cleaned.

### BRIEF DESCRIPTION OF THE INVENTION

Therefore, an object of the present invention is to provide a microwave cooker capable of enhancing a microwave leakage blocking function and easily cleaning inside of a body.

To achieve these and other advantages and in accordance with the purpose of the present invention, as embodied and broadly described herein, there is provided a microwave cooker, comprising: a body having a cooking chamber therein for forming an appearance of the microwave cooker; a microwave source disposed at the body for supplying microwave to the cooking chamber; a door openably coupled to one side of the body for opening and closing the cooking chamber; and a choke seal formed at the door and having a resonant frequency at a frequency region higher than a central frequency of microwave when the cooking chamber is closed by the door, for preventing the microwave from being leaked between the body and the door.

The choke seal has an LC resonant circuit comprising an inductance (L) and a capacitance (C) connected to the inductance in parallel.

The choke seal comprises a cavity having an opening towards a front surface of the body, a groove formed at a circumferential surface of the door, and a control plate extending from a side wall of the groove for partially covering the opening.

A difference between the resonant frequency of the choke seal and the central frequency of the microwave is within 250 MHz.

When the door is initially opened, the resonant frequency of the choke seal is approximately the central frequency of the microwave.

Preferably, a transparent window for viewing inside of the cooking chamber is coupled to the door so as to be disposed between the door and the body, and has a size corresponding to a size of a front surface of the body.

Preferably, the control plate is formed along a plate surface direction of the door so as to come in contact with the transparent window.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a graph showing a microwave damping curve of a microwave cooker in accordance with the conventional art;

FIG. 2 is a perspective view showing a structure of a microwave cooker according to a first embodiment of the present invention;

FIG. 3 is a sectional view taken along line I-I of FIG. 2;

FIG. 4 is an LC resonant circuit diagram applied to a choke seal of the microwave cooker according to the first embodiment of the present invention;

FIG. 5 is a perspective view showing a structure of the choke seal of the microwave cooker according to the first embodiment of the present invention;

FIG. 6 is a graph showing a microwave damping curve by the choke seal of the microwave cooker according to the first embodiment of the present invention;

FIGS. 7 and 8 are perspective views showing a structure of a choke seal of a microwave cooker according to a second embodiment of the present invention;

FIG. 9 is an LC resonant circuit diagram applied to the choke seal of FIGS. 7 and 8;

FIGS. 10 and 11 are views for explaining a principle of the choke seal applied to FIGS. 2 to 9;

FIG. 12 is a sectional view showing a structure of a multi-stage choke seal of a microwave cooker according to a third embodiment of the present invention;

FIG. 13 is a perspective view showing the structure of a multi-stage choke seal of a microwave cooker according to the third embodiment of the present invention;

FIG. 14 is an LC resonant circuit diagram applied to the multi-stage choke seal of the microwave cooker according to the third embodiment of the present invention;

FIG. 15 is a view showing a microwave damping curve by the multi-stage choke seal of the microwave cooker according to the third embodiment of the present invention;

FIG. 16 is a view for comparing the microwave damping curve of FIG. 15 with a conventional microwave damping curve;

FIG. 17 is an LC resonant circuit diagram applied to a multi-stage choke seal of a microwave cooker according to a fourth embodiment of the present invention;

FIG. 18 is a perspective view showing a structure of a multi-stage choke seal of a microwave cooker according to a fifth embodiment of the present invention; and

FIG. 19 is a sectional view showing the structure of a multi-stage choke seal of a microwave cooker according to a fifth embodiment of the present invention.

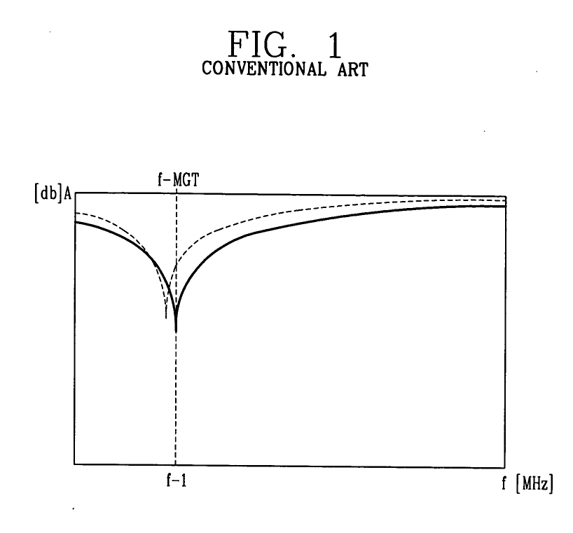

### DETAILED DESCRIPTION OF THE INVENTION

Reference will now be made in detail to the preferred embodiments of the present invention, examples of which are illustrated in the accompanying drawings.

Hereinafter, a microwave cooker of the present invention will be explained in more detail.

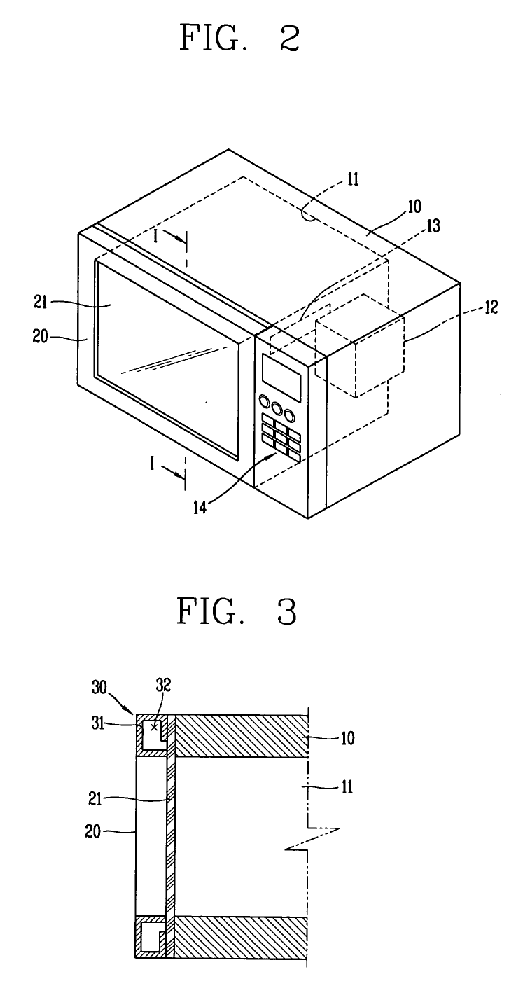

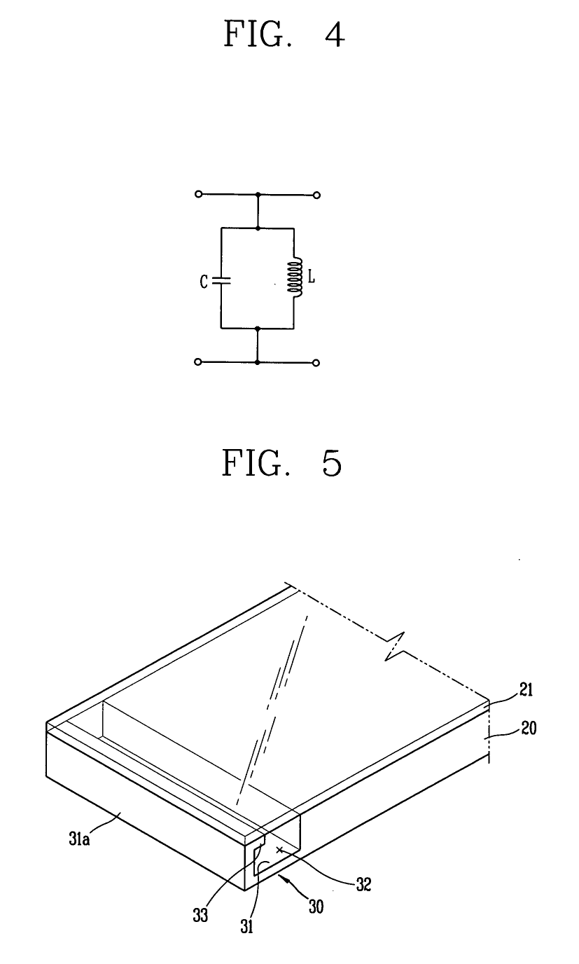

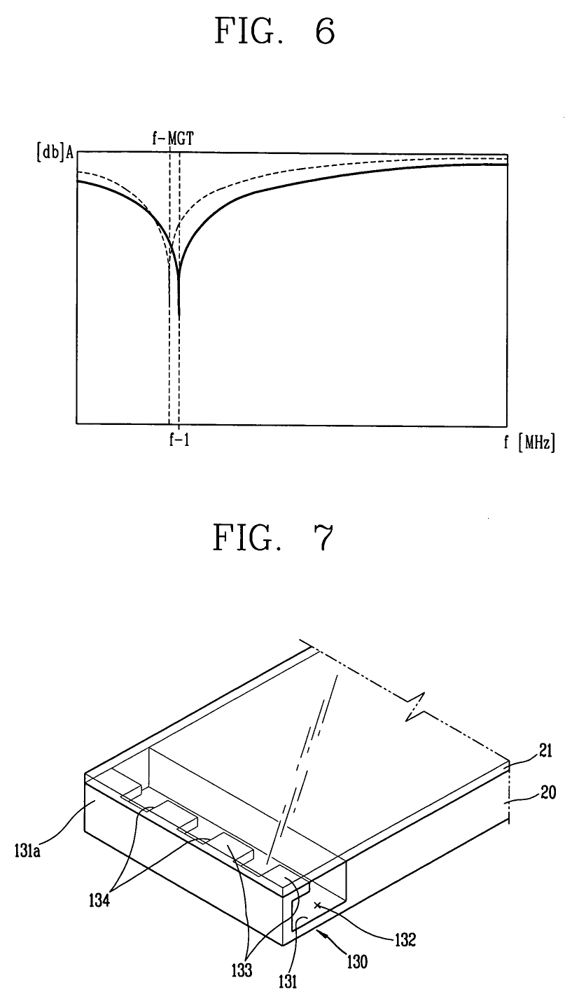

FIG. 2 is a perspective view showing a structure of a microwave cooker according to a first embodiment of the present invention, FIG. 3 is a sectional view taken along line I-I of FIG. 2, FIG. 4 is an LC resonant circuit diagram applied to a choke seal of the microwave cooker according to the first embodiment of the present invention, FIG. 5 is a perspective view showing a structure of the choke seal of the microwave cooker according to the first embodiment of the present invention, and FIG. 6 is a graph showing a microwave damping curve by the choke seal of the microwave cooker according to the first embodiment of the present invention.

As shown in FIGS. 2 to 6, a microwave cooker according to the first embodiment of the present invention comprises a body 10 having a cooking chamber 11 therein for forming an appearance of the microwave cooker, a microwave source 12 disposed at the body 10 for supplying microwave to the cooking chamber 11, a door 20 openably coupled to one side of the body 10 for opening and closing the cooking chamber 11, and a choke seal 30 formed at the door 20 and having a resonant frequency (f-1) at a frequency region higher than a central frequency (f-MGT) of microwave when the cooking chamber 11 is closed by the door 20, for preventing the microwave from being leaked between the body 10 and the door 20.

A microwave supplying unit 13 for supplying microwave generated from the microwave source 12 to the cooking chamber 11 is disposed at the body 10, and an adjustment unit 14 for controlling each kind of component and selecting a cooking mode is installed at a right side of a front surface of the body 10.

The choke seal 30 is an open-type choke seal having an LC resonant circuit comprising an inductance (L) and a capacitance (C) connected to the inductance in parallel at a resonant portion. Also, the choke seal 30 has a resonant frequency (f-1) at a frequency region higher than a central frequency (f-MGT) of microwave when the cooking chamber 11 is closed by the door 20.

More specifically, the choke seal 30 comprises a groove 31 curvedly-extending at a circumferential surface of the door 20 and having a single cavity 32 provided with an opening towards a front surface of the body 10. The groove 30 has a length corresponding to ¼ of a wavelength when the cooking chamber 11 is closed by the door 20.

The resonant frequency (f-1) of the choke seal 30 can be varied by controlling a structure, a size, etc. of the cavity so that the inductance L and the capacitance C can be varied.

The choke seal 30 can further comprise a control plate 33 extending from a side wall 31a of the groove 31 for partially covering the opening of the cavity 32.

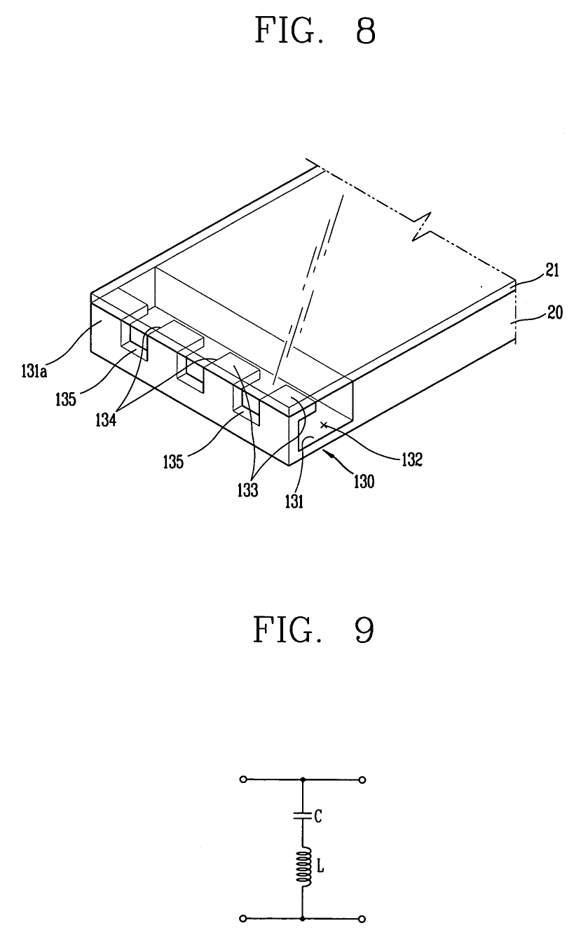

FIGS. 7 and 8 are perspective views showing a structure of a choke seal of a microwave cooker according to a second embodiment of the present invention, and FIG. 9 is an LC resonant circuit diagram applied to the choke seal of FIGS. 7 and 8.

As shown in FIGS. 7 to 9, in a microwave cooker according to a second embodiment of the present invention, a choke seal 130 is a short-type choke seal having an LC resonant circuit comprising an inductance (L) and a capacitance (C) connected to the inductance in series at a resonant portion.

In the microwave cooker of the second embodiment, likewise the microwave cooker of the first embodiment, the choke seal 130 has a resonant frequency (f-1) at a frequency region higher than the central frequency (f-MGT) of microwave when the cooking chamber 11 is closed by the door 20 as shown in FIG. 6.

In the microwave cooker according to the second embodiment of the present invention, the choke seal 130 comprises a groove 131 formed at a circumferential surface of the door 20 and having a cavity 132 provided with an opening towards a front surface of the body 10, a control plate 133 curvedly-extending from a side wall 131a of the groove 131 for partially covering the opening, and slots 134 formed at the control plate 133 with a certain interval along a progressive direction of microwave in a circumferential direction of the door 20.

The resonant frequency (f-1) of the choke seal 130 can be varied by controlling a structure, a size, etc. of each portion corresponding to the inductance L and the capacitance C.

In the microwave cooker according to the first embodiment and the second embodiment, the central frequency (f-MGT) of microwave is 2450 MHz when the cooking chamber 11 is closed by the door 20. Herein, a difference between the resonant frequency (f-1) of each choke seal 30 and 130 and the central frequency (f-MGT) of microwave is within a range of 250 MHz.

That is, when the door 20 is initially opened (that is, when the door 20 is opened for a certain section before the microwave source 12 is completely turned off, and thus when a gap is generated between the body 10 and the door 20), the resonant frequency of the choke seal of the microwave cooker is moved within a range of 200 MHz. When the difference between the resonant frequency (f-1) of each choke seal 30 and 130 and the central frequency (f-MGT) of microwave is more than 250 MHz, an optimum microwave damping function provided from each choke seal 30 and 130 is not implemented when the door 20 is initially opened. Therefore, the difference between the resonant frequency (f-1) of each choke seal 30 and 130 and the central frequency (f-MGT) of the microwave has to be within 250 MHz.

A leakage amount (L) of microwave is increased in proportion to a cube of a gap G between the body 10 and the door 20 when the gap is less than a wavelength (λ) of microwave. Therefore, when the cooking chamber 11 is closed by the door 20, the leakage amount (L) from the gap becomes different according to a tuned position of the resonant frequency (f-1) of each choke seal 30 and 130.

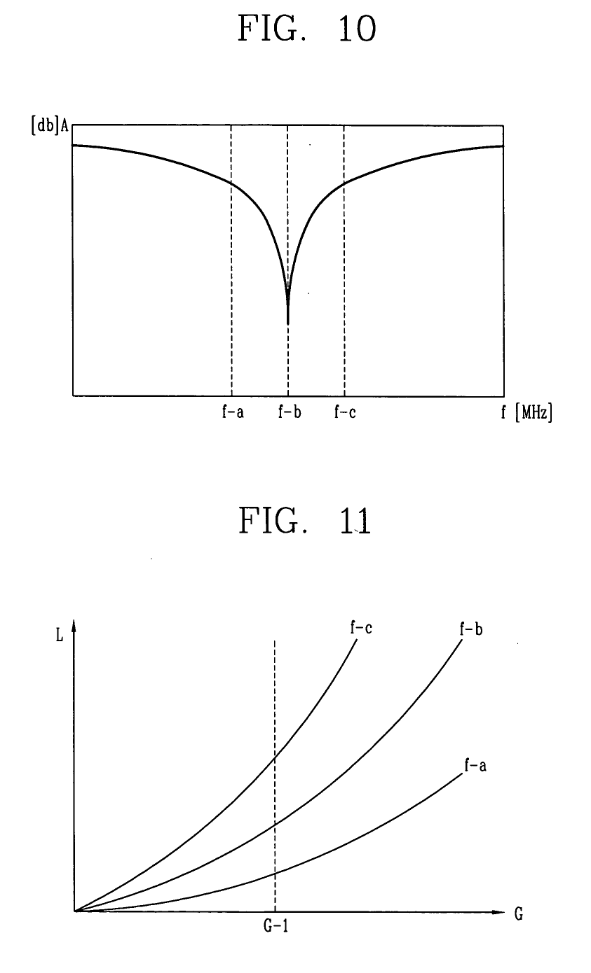

As shown in FIGS. 10 and 11, when the cooking chamber 11 is closed by the door 20, the leakage amount (L) from the gap G between the body 10 and the door 20 becomes different according to a tuned position of the resonant frequency (f-1) of each choke seal 30 and 130 among f-a, f-b, and f-c. In the present invention, the resonant frequency (f-1) of each choke seal 30 and 130 is tuned to be positioned at the f-a region, thereby effectively blocking a microwave leakage from a gap (G-1) by which the microwave source 12 is turned off when the door 20 is opened.

When the door 20 is initially opened, the resonant frequency (f-1) of each choke seal 30 and 130 is approximately equal to the central frequency (f-MGT) of the microwave in order to implement an optimum damping function.

In the microwave cooker according to the first embodiment and the second embodiment of the present invention, the central frequency (f-MGT) of microwave is equal to the resonant frequency (f-1) of each choke seal 30 and 130 when the door 20 is initially opened. Accordingly, an optimum microwave damping function provided from the choke seals 30 and 130 is implemented when the door 20 is initially opened (that is, even if when a gap is generated between the body 10 and the door 20 before the microwave source 12 is completely turned off. Also, a microwave leakage blocking function can be enhanced.

As shown in FIG. 8, in the microwave cooker according to the second embodiment of the present invention, the choke seal 130 further comprises a slit 135 having a certain depth to be connected to the slot 134 and formed at the side wall 131a of the groove 131 from which the control plate 133 is extending. A microwave damping function can be stably implemented according to a variation of an incident angle of electromagnetic wave by the slit 135.

A transparent window 21 for viewing inside of the cooking chamber 11 is formed of glass, plastic, etc., and is coupled to the door 20 according to the first embodiment and the second embodiment. The transparent window 21 has a size corresponding to a size of a front surface of the body 10, and is coupled to the door 20 so as to be disposed between the body 10 and the door 20.

The inner surface of the door 20 is entirely covered with the transparent window 21, so that an additional choke cover for covering the choke seals 30 and 130 (not shown) is not required.

Also, the inner surface of the door 20 has an improved design, and the inner surface of the door 20, especially, the choke seal 30 that is not easily cleaned is prevented from being contaminated by odor, smoke, etc. generated from the cooking chamber 11. Also, the door 20 can be easily cleaned.

Furthermore, the control plates 33 and 133 according to the first embodiment and the second embodiment are preferably formed along a plate surface direction of the door 20 so as to come in contact with the transparent window 21.

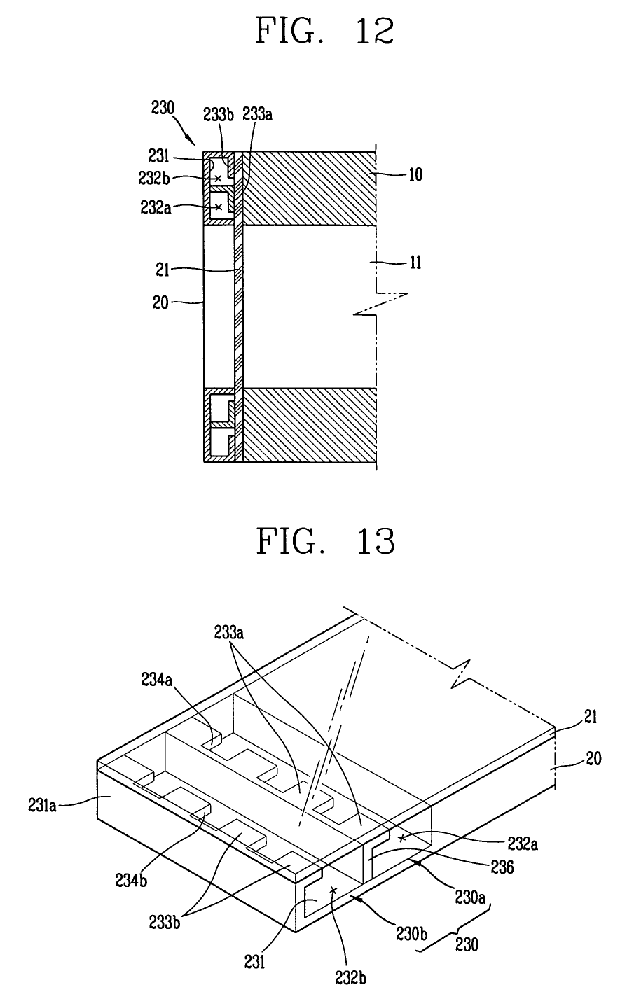

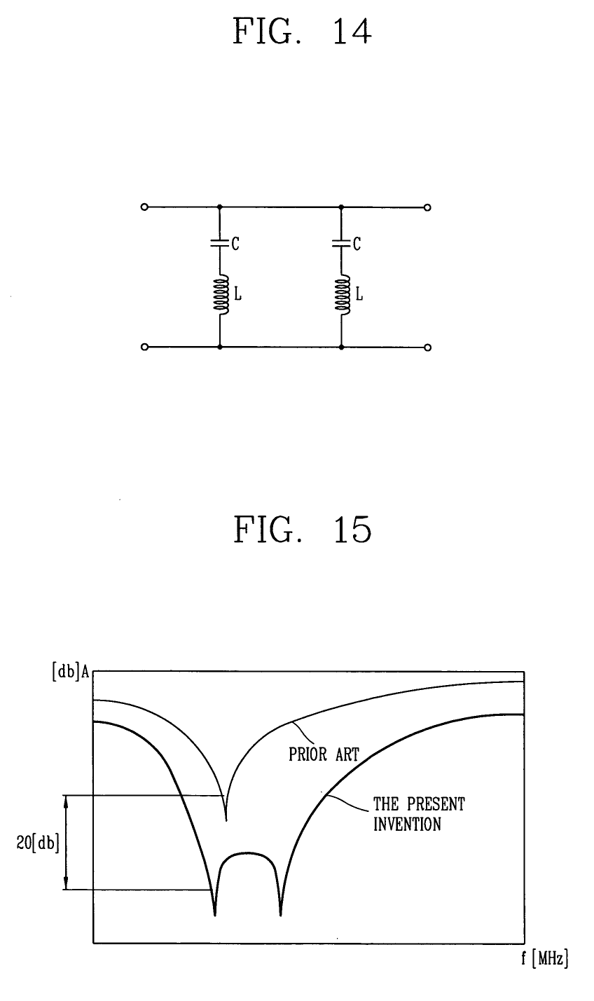

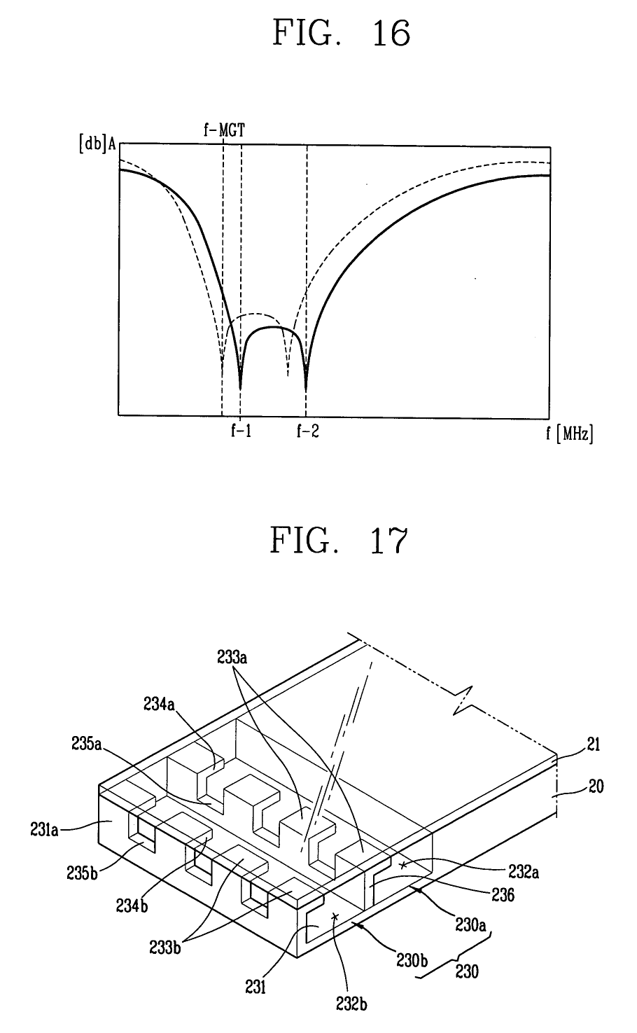

FIG. 12 is a sectional view showing a structure of a multi-stage choke seal of a microwave cooker according to a third embodiment of the present invention, FIG. 13 is a perspective view showing the structure of a multi-stage choke seal of a microwave cooker according to the third embodiment of the present invention, FIG. 14 is an LC resonant circuit diagram applied to the multi-stage choke seal of the microwave cooker according to the third embodiment of the present invention, FIG. 15 is a view showing a microwave damping curve by the multi-stage choke seal of the microwave cooker according to the third embodiment of the present invention, and FIG. 16 is a view for comparing the microwave damping curve of FIG. 15 with a conventional microwave damping curve.

In the microwave cooker according to the third embodiment of the present invention, the same reference numerals were given to the same parts as those of the microwave cookers according to the first and second embodiments, and detail explanation thereof will be omitted.

As shown in FIGS. 12 to 17, the microwave cooker according to the third embodiment comprises a body 10 having a cooking chamber 11 therein for forming an appearance of the microwave cooker, the cooking chamber 11 having one opened side, a microwave source 12 disposed at the body 10 for supplying microwave to the cooking chamber 11, a door 20 rotatably coupled to a front surface of the body 10 for opening and closing the cooking chamber 11, and a multi-stage choke seal 230 formed at the door 20 and having different resonant frequencies (f-1, f-2) at a frequency region higher than a central frequency (f-MGT) of microwave when the cooking chamber 11 is closed by the door 20, for preventing the microwave from being leaked from a gap between the body 10 and the door 20.

The multi-stage choke seal 230 comprises a first choke seal 230a and a second choke seal 230b cascaded to be in parallel with each other. The first choke seal 230a and the second choke seal 230b have the same LC resonant circuit.

That is, the first choke seal 230a and the second choke seal 230b are short type choke seals, each having an LC resonant circuit comprising an inductance (L) and a capacitance (C) connected to the inductance at a resonant portion in series. When the cooking chamber 11 is closed by the door 20, the first choke seal 230a and the second choke seal 230b have different resonant frequencies (f-1, f-2) at a frequency region higher than the central frequency (f-MGT) of microwave.

The multi-stage choke seal 230 comprises a groove 231 formed at a circumferential surface of the door 20 and having a first cavity 232a and a second cavity 232b separated from each other by a partition wall 236, each cavity having an opening towards a front surface of the body 10, control plates 233a and 233b curvedly extending from the partition wall 236 and a side wall 231a of the groove 231 for partially covering each opening, and slots 234a and 234b formed at the control plates 233a and 233b with a certain interval along a progressive direction of microwave in a circumferential direction of the door 20.

The partition wall 236 is fixed to a lower surface of the groove 231 in parallel with the side wall 231a of the groove 231 by a welding or a screw joint. The resonant frequencies (f-1, f-2) of the first choke seal 230a and the second choke seal 230b can be varied by controlling a structure, a size, etc. of each portion corresponding to the inductance L and the capacitance C.

In the microwave cooker according to the third embodiment of the present invention, when the cooking chamber 11 of the body 10 is closed by the door 20, the central frequency (f-MGT) of microwave is 2450 MHz, and a difference between each resonant frequency (f-1, f-2) of the multi-stage choke seal 230 is within 400 MHz.

When the difference between each resonant frequency (f-1, f-2) of the multi-stage choke seal 230 is more than 400 MHz, a microwave damping function is lowered at each resonant frequency region (f-1, f-2) even if a wide bandwidth can be obtained. Therefore, the difference between each resonant frequency (f-1, f-2) of the multi-stage choke seal 230 is within 400 MHz, more preferably, within 200 MHz.

A difference between the resonant frequency (f-1) adjacent to the central frequency (f-MGT) of microwave of each resonant frequency (f-1, f-2) of the multi-stage choke seal 230 and the central frequency (f-MGT) of microwave is within 250 MHz.

When the difference between the resonant frequency (f-1) adjacent to the central frequency (f-MGT) of microwave of each resonant frequency (f-1, f-2) of the multi-stage choke seal 230 and the central frequency (f-MGT) of microwave is more than 250 MHz, an optimum microwave damping function provided from the multi-stage choke seal 230 is not implemented when the door 20 is initially opened. Therefore, the difference between the resonant frequency (f-1) adjacent to the central frequency (f-MGT) of microwave of each resonant frequency (f-1, f-2) of the multi-stage choke seal 230 and the central frequency (f-MGT) of the microwave has to be within 250 MHz.

In order to implement an optimum microwave damping function when the door 20 is initially opened, one of each resonant frequency (f-1, f-2) of the multi-stage choke seal 230 is constructed to be approximately equal to the central frequency (f-MGT) of the microwave.

In the microwave cooker according to the third embodiment of the present invention, the resonant frequencies (f-1 and f-2) of the multi-stage choke seal 230 are disposed to be adjacent to each other within an interactive frequency range. Accordingly, a microwave damping function is increased by at least 20 dB when compared with the conventional damping function, and a microwave leakage blocking function is enhanced according to a variation of the gap between the body 10 and the door 20.

Furthermore, in the present invention, each resonant frequency (f-1 and f-2) of the multi-stage choke seal 230 are disposed at a frequency region higher than the central frequency (f-MGT) of microwave, and one of the resonant frequencies (f-1 and f-2) has the same frequency as the central frequency (f-MGT) of microwave when the door 20 is initially opened. Therefore, even if a gap between the body 10 and the door 20 is generated before the microwave source 12 is completely turned off when the door 20 is initially opened, an optimum damping function provided from the multi-stage choke seal 230 can be implemented. Also, even if a large gap more than approximately 4 mm is generated between the body 10 and the door 20, a microwave leakage blocking is effectively performed.

In the microwave cooker according to the third embodiment of the present invention, the slits 235a and 235b are respectively formed at the partition wall 236 from which the control plates 233a and 233b are extending and at the side wall 231a of the groove 231. However, the slit can be formed at one side of the partition wall 236 and the side wall 231a of the groove 231.

FIG. 17 is an LC resonant circuit diagram applied to a multi-stage choke seal of a microwave cooker according to a fourth embodiment of the present invention.

As shown in FIG. 17, the multi-stage choke seal 230 according to the fourth embodiment of the present invention can further comprise the slits 235a and 235b each having a certain depth so as to be connected to each slot 234a and 234b, and formed at the partition wall 236 from which each control plate 233a and 233b is extending and at the side wall 231a of the groove 231. A microwave damping function can be stably implemented according to a variation of an incident angle of electromagnetic wave by the slits 235a and 235b.

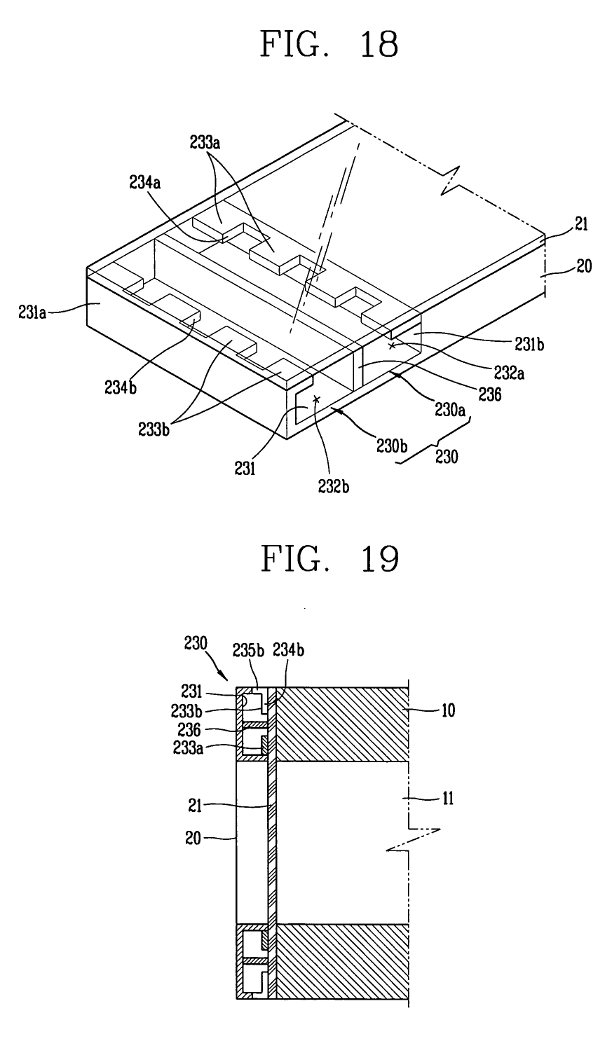

FIG. 18 is a perspective view showing a structure of a multi-stage choke seal of a microwave cooker according to a fifth embodiment of the present invention, and FIG. 19 is a sectional view showing the structure of a multi-stage choke seal of a microwave cooker according to a fifth embodiment of the present invention.

As shown in FIGS. 18 and 19, in the microwave cooker according to the fifth embodiment of the present invention, the multi-stage choke seal 230 comprises a groove 231 formed at a circumferential surface of the door 20 and having a first cavity 232a and a second cavity 232b separated from each other by a partition wall 236, each cavity having an opening towards a front surface of the body 10, control plates 233a and 233b curvedly extending from both side walls 231a and 231b of the groove 231 towards the partition wall 236 for partially covering each opening, and slots 234a and 234b formed at the control plates 233a and 233b with a certain interval along a progressive direction of microwave in a circumferential direction of the door 20.

It is also possible to form the slit 235b having a certain depth so as to be connected to the slot 234b at the side wall 231a of the groove 231 from which the control plate 233b for covering the opening of the second cavity 232b is extending.

In the microwave cooker according to the fifth embodiment of the present invention, a transparent window 21 for viewing inside of the cooking chamber 11 is formed of plastic, etc., and is coupled to the door 20. The transparent window 21 has a size corresponding to a size of a front surface of the body 10, and is coupled to the door 20 so as to be disposed between the body 10 and the door 20.

The inner surface of the door 20 is entirely covered with the transparent window 21, so that an additional choke cover (not shown) for covering the multi-stage choke seal 230 is not required. Also, the inner surface of the door 20 has an improved design, and the inner surface of the door 20, especially, the choke seal 30 that is not easily cleaned is prevented from being contaminated by odor, smoke, etc. generated from the cooking chamber 11. Also, the door 20 can be easily cleaned.

Each control plate 233a and 233b of the multi-stage choke seal 230 is formed along a plate surface direction of the door 20 so as to come in contact with the transparent window 21.

As aforementioned, in the microwave cooker according to the present invention, a microwave leakage blocking function can be enhanced.

Especially, a microwave leakage blocking function can be stably implemented according to a variation of a gap between the body and the door by a microwave damping function enhanced than the conventional microwave damping function. Also, even if the gap between the body 10 and the door 20 is generated, an optimum damping function is implemented thereby to effectively prevent a microwave leakage.

Furthermore, the inner surface of the door can have an improved design and the door can be easily cleaned.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A microwave cooker, comprising:
a body having a cooking chamber therein for forming an appearance of the microwave cooker;
a microwave source disposed at the body for supplying microwave to the cooking chamber;
a door openably coupled to one side of the body for opening and closing the cooking chamber; and
a choke seal formed at the door and having a resonant frequency at a frequency region higher than a central frequency of microwave when the cooking chamber is closed by the door, for preventing the microwave from being leaked between the body and the door.

2. The microwave cooker of claim 1, wherein the choke seal has an LC resonant circuit comprising an inductance and a capacitance connected to the inductance in parallel.

3. The microwave cooker of claim 2, wherein the choke seal comprises:
a cavity having an opening towards a front surface of the body; and
a groove formed at a circumferential surface of the door.

4. The microwave cooker of claim 3, further comprising a control plate extending from a side wall of the groove for partially covering the opening.

5. The microwave cooker of claim 1, wherein the choke seal has an LC resonant circuit comprising an inductance and a capacitance connected to the inductance in series.

6. The microwave cooker of claim 5, wherein the choke seal comprises:
a groove having a cavity provided with an opening towards a front surface of the body and formed at a circumferential surface of the door;
a control plate extending from a side wall of the groove for partially covering the opening; and
slots formed at the control plate with a certain interval in a circumferential direction of the door.

7. The microwave cooker of claim 6, wherein a slit connected to the slot is formed at the side wall of the groove from which the control plate is extending.

8. The microwave cooker of claim 1, wherein a difference between the resonant frequency of the choke seal and the central frequency of the microwave is within 250 MHz.

9. The microwave cooker of claim 8, wherein when the door is initially opened, the resonant frequency of the choke seal is approximately the central frequency of the microwave.

10. The microwave cooker of claim 9, wherein a transparent window for viewing inside of the cooking chamber is coupled to the door so as to be disposed between the door and the body, and has a size corresponding to a size of a front surface of the body.

11. The microwave cooker of claim 10, wherein the control plate is formed along a plate surface direction of the door so as to come in contact with the transparent window.

12. A microwave cooker, comprising:
a microwave source for supplying microwave to a cooking chamber of a body;
a door coupled to the body for opening and closing the cooking chamber; and
a multi-stage choke seal formed at the door and having a resonant frequency at a frequency region higher than a central frequency of microwave when the cooking chamber is closed by the door, for preventing the microwave from being leaked between the body and the door.

13. The microwave cooker of claim 12, wherein the multi-stage choke seal comprises a first choke seal and a second choke seal cascaded to be in parallel with each other.

14. The microwave cooker of claim 13, wherein the first choke seal and the second choke seal have an identical LC resonant circuit, respectively.

15. The microwave cooker of claim 14, wherein the LC resonant circuit of the first choke seal and the second choke seal comprises an inductance and a capacitance connected to the inductance in series.

16. The microwave cooker of claim 15, wherein the multi-stage choke seal comprises:
a groove formed at a circumferential surface of the door and having a first cavity and a second cavity separated from each other by a partition wall, each cavity having an opening towards a front surface of the body;
control plates extending from the partition wall and a side wall of the groove for partially covering each opening; and
slots formed at the control plates with a certain interval in a circumferential direction of the door.

17. The microwave cooker of claim 16, wherein slits connected to the slots are formed on at least one side of the partition wall from which the control plates are extending and the side wall of the groove.

18. The microwave cooker of claim 15, wherein the multi-stage choke seal comprises:
a groove formed at a circumferential surface of the door and having a first cavity and a second cavity separated from each other by a partition wall, each cavity having an opening towards a front surface of the body;
control plates extending from both side walls of the groove for partially covering each opening; and
slots formed at the control plates with a certain interval in a circumferential direction of the door.

19. The microwave cooker of claim 18, wherein a slit connected to the slot formed at the control plate disposed at an outer side along a plate surface direction of the door is formed at the side wall of the groove.

20. The microwave cooker of claim 12, wherein a difference between each resonant frequency of the multi-stage choke seal is within 400 MHz.

21. The microwave cooker of claim 20, wherein a difference between the resonant frequency of the multi-stage choke seal adjacent to a central frequency of microwave and the central frequency of the microwave is within 250 MHz.

22. The microwave cooker of claim 21, wherein when the door is initially opened, one of each resonant frequency of the multi-stage choke seal is approximately the central frequency of the microwave.

23. The microwave cooker of claim 22, wherein a transparent window for viewing inside of the cooking chamber is coupled to the door so as to be disposed between the door and the body, and has a size corresponding to a size of a front surface of the body.

24. The microwave cooker of claim 23, wherein each of the control plates is formed along a plate surface direction of the door so as to come in contact with the transparent window.

25. A microwave cooker, comprising:
a body having a cooking chamber therein, the cooking chamber having one opened side;
a microwave source disposed at the body for supplying microwave to the cooking chamber;
a door openably coupled to the body for opening and closing the cooking chamber; and
a multi-stage choke seal formed at the door for preventing the microwave from being leaked between the body and the door, the multi-stage choke seal comprising:
a groove formed at a circumferential surface of the door and having a first cavity and a second cavity separated from each other by a partition wall, each cavity having an opening towards a front surface of the body;
control plates extending from the partition wall and a side wall of the groove for partially covering each opening; and
slots formed at each control plate with a certain interval in a circumferential direction of the door.

26. The microwave cooker of claim 25, wherein slits connected to the slots are formed on at least one side of the partition wall from which each control plate is extending and the side wall of the groove.

27. The microwave cooker of claim 25, wherein a transparent window for viewing inside of the cooking chamber is coupled to the door so as to be disposed between the door and the body, and has a size corresponding to a size of a front surface of the body.

28. The microwave cooker of claim 27, wherein each of the control plates is formed along a plate surface direction of the door so as to come in contact with the transparent window.

29. The microwave cooker of claim 28, wherein the choke seal has a resonant frequency at a frequency region higher than a central frequency of microwave when the cooking chamber is closed by the door.

30. The microwave cooker of claim 29, wherein a difference between each resonant frequency of the multi-stage choke seal is within 400 MHz.

31. The microwave cooker of claim 30, wherein a difference between the resonant frequency of the multi-stage choke seal adjacent to the central frequency of microwave and the central frequency of the microwave is within 250 MHz.

32. The microwave cooker of claim 31, wherein when the door is initially opened, one of each resonant frequency of the multi-stage choke seal is approximately the central frequency of the microwave.

33. A microwave cooker, comprising:
a body having a cooking chamber therein, the cooking chamber having one opened side;
a microwave source disposed at the body for supplying microwave to the cooking chamber;
a door coupled to the body for opening and closing the cooking chamber; and
a multi-stage choke seal formed at the door for preventing the microwave from being leaked between the body and the door, the multi-stage choke seal comprising:
a groove formed at a circumferential surface of the door and having a first cavity and a second cavity separated from each other by a partition wall, each cavity having an opening towards a front surface of the body;
control plates extending from both side walls of the groove for partially covering each opening; and
slots formed at each control plate with a certain interval in a circumferential direction of the door.

34. The microwave cooker of claim 33, wherein a slit connected to the slot formed at the control plate disposed at an outer side along a plate surface direction of the door is formed at the side wall of the groove.

35. The microwave cooker of claim 33, wherein a transparent window for viewing inside of the cooking chamber is coupled to the door so as to be disposed between the door and the body, and has a size corresponding to a size of a front surface of the body.

36. The microwave cooker of claim 35, wherein each of the control plates is formed along a plate surface direction of the door so as to come in contact with the transparent window.

37. The microwave cooker of claim 36, wherein the multi-stage choke seal has a resonant frequency at a frequency region higher than a central frequency of microwave when the cooking chamber is closed by the door.

38. The microwave cooker of claim 37, wherein a difference between each resonant frequency of the multi-stage choke seal is within 400 MHz.

39. The microwave cooker of claim 38, wherein a difference between the resonant frequency of the multi-stage choke seal adjacent to the central frequency of microwave and the central frequency of the microwave is within 250 MHz.

40. The microwave cooker of claim 39, wherein when the door is initially opened, one of each resonant frequency of the multi-stage choke seal is approximately the central frequency of the microwave.
